(19) United States
(12) Patent Application Publication
(10) Pub. No.: US 2014/0036258 A1
(43) Pub. Date: Feb. 6, 2014

(54) OPTICAL TRANSMISSION LINE CONNECTION SYSTEM AND OPTICAL TRANSMISSION LINE CONNECTION METHOD

(71) Applicants: Kentaro Nakamura, Tokyo (JP); Yosuke Mizuno, Tokyo (JP)

(72) Inventors: Kentaro Nakamura, Tokyo (JP); Yosuke Mizuno, Tokyo (JP)

(73) Assignee: TOKYO INSTITUTE OF TECHNOLOGY, Tokyo (JP)

(21) Appl. No.: 14/111,583

(22) PCT Filed: Apr. 6, 2012
(86) PCT No.: PCT/JP2012/059502

§ 371 Date: Oct. 14, 2013

(30) Foreign Application Priority Data
Apr. 15, 2011 (JP) 2011-090924

(51) Int. Cl. G01B 11/27

(52) U.S. Cl. CPC G01B 11/27
USPC 356/153

(57) ABSTRACT

An optical transmission line connection system includes a light source unit that outputs laser light, a pump light generation unit that allows the laser light outputted from the light source unit to pass through one end of an optical transmission line and be made incident on one end of another optical transmission line as pump light, a measurement unit that measures non-linear scattered light components contained in reflected light, and a control unit that evaluates a spectrum of the non-linear scattered components observed by the measurement unit, and controls positions of optical axes of the one end of the one optical transmission line and the one end of the other optical transmission line so as to position the optical axes and maximize an intensity of the non-linear scattered light components.

### FIELD OF THE INVENTION

This invention relates to an optical transmission line connection system which allows optical transmission lines to be mutually abutted against and joined to each other and an optical transmission line connection method for such a system. The present application asserts priority rights based on JP Patent Application 2011-090924 filed in Japan on Apr. 15, 2011. The total contents of disclosure of the patent application of the senior filing date are to be incorporated by reference into the present application.

### BACKGROUND OF THE INVENTION

In the case when connectors (FC, SC, LC or the like) are attached to ends of an optical fiber that is one example of an optical transmission line, positioning processes of core centers are easily carried out with high precision by using an adapter corresponding to the connector. However, in the case when no connectors are attached to ends of an optical fiber, for example, the optical fiber needs to be secured onto a multi-axial movable stage and position-adjusted, that is, the optical fibers have to be abutted against and joined to each other. In order to mutually connect optical fibers efficiently without using connectors, position-adjusting processes of the core centers with high precision of the two fibers are essentially required.

In a conventionally general method, output light from an end of an optical fiber forming the connection end is monitored and the position-adjusting processes are carried out so as to make the monitored light maximized. In some cases, however, this method is not effective.

For example, those cases typically include a case in which the optical fiber forming the connection end is embedded in a material or a structural object as a sensing head of an optical fiber sensor. Moreover, another case is considered in which the optical fiber end forming the connection end is located at a very far away position. Furthermore, still another case is considered in which light attenuation in an optical fiber forming the connection end is extremely high with the result that no output light is observed. In particular, in recent years, studies have been vigorously made so as to use, as the sensing head of an optical fiber sensor, not only a silica fiber that is low in light attenuation, but also a multimode fiber, typically represented by a polymer optical fiber (optical fibers made of plastic materials) that is highly functional although its light attenuation is high. The highly functional polymer optical fiber refers to, for example, such a fiber as to be durable, inexpensive and easily handled, or such a fiber as to provide specific strong scattered light, or greatly react (or hardly react) with an environment having high strains or temperature changes.

In the above-mentioned cases, since the method in which output light from an end of an optical fiber forming the connection end is monitored and the position-adjusting processes are carried out so as to make the monitored light maximized is sometimes not so effective, the position adjusting processes need to be optimized only on a light incident side of the optical fiber end forming the connection end.

As a conventional technique in which the position adjusting processes are carried out only on the light incident side of the optical fiber end forming the connection end, for example, a technique has been known in which position adjustments are visually carried out by using a CCD camera (for example, see Patent Document 1).

### Patent Document

PTL 1: Japanese Patent Application Laid-Open No. 2005-189770

However, as in the case of the above-mentioned conventional technique, a device for use in carrying out the position adjusting processes only on the light incident side of the optical fiber end forming the connection end is generally very expensive, and a large-scale device is required. Moreover, the technique for carrying out the position adjusting processes only on the light incident side of the optical fiber end forming the connection end needs to preliminarily carry out a programming process of connection conditions, and fails to apply to a connection with an optical fiber having a novel material or structure (in particular, core sizes) in many cases.

### SUMMARY OF THE INVENTION

One or more embodiments of the present invention provide an optical transmission line connection system capable of effectively carrying out mutual connections of optical transmission lines without the necessity of connectors, and an optical transmission line connection method for such a system. Other advantages of one or more embodiments of the present invention will become apparent from the description which follows, considered in light of the accompanying drawing.

In one or more embodiments of the present invention, an optical transmission line connection system for allowing two optical transmission lines to be abutted against and joined to each other is provided with: a light source unit that outputs laser light; a pump light generation unit that allows the laser light outputted from the light source unit to pass through one end of one of the optical transmission lines and be made incident on one end of the other optical transmission line as pump light; a measurement unit that measures non-linear scattered light components contained in reflected light, with the reflected light being derived from the pump light transmitted through inside the other optical transmission line; and a control unit that evaluates a spectrum of the non-linear scattered components observed by the measurement unit, and controls positions of optical axes of the one end of the one optical transmission line and the one end of the other optical transmission line so as to position the optical axes and maximize an intensity of the non-linear scattered light components.

Moreover, in one or more embodiments of the present invention, an optical transmission line connecting method for allowing two optical transmission lines to be abutted against and joined to each other comprises: allowing a light source unit to output laser light; allowing the laser light outputted from the light source unit to pass through one end of one of the optical transmission lines and be made incident on one end of the other optical transmission line as pump light; observing non-linear scattered light components contained in reflected light, with the reflected light being derived from the pump light transmitted through inside the other optical transmission line; and by evaluating the spectrum of the non-linear scattered components measured by the measuring, controlling positions of optical axes of the one end of the one optical transmission line and the one end of the other optical transmission line so as to position the optical axes and maximize an intensity of the non-linear scattered light components.

In accordance with one or more embodiments of the present invention, by optimizing a position adjusting process only on a light incident side of the optical transmission line forming the connection end, the core centers of optical transmission lines can be mutually position-adjusted with high precision; therefore, it becomes possible to mutually connect the optical transmission lines efficiently without using a connector.

### BRIEF DESCRIPTION OF DRAWINGS

FIG. 1 is a block diagram showing a structural example of an optical transmission line connection system according to one or more embodiments.

FIG. 2 is a view that schematically shows an optical transmission line according to one or more embodiments.

FIG. 3 is a block diagram showing another structural example of an optical transmission line connection system according to one or more embodiments.

FIG. 4 is a block diagram showing the other structural example of an optical transmission line connection system according to one or more embodiments.

FIG. 5 is a flow chart for use in explaining an optical transmission line connection method according to one or more embodiments.

FIG. 6 is a flow chart for use in explaining connection steps according to one or more embodiments.

FIG. 7 is a flow chart for use in explaining another optical transmission line connection method according to one or more embodiments.

FIG. 8 is a graph showing measurement results of a Brillouin gain spectrum according to one or more embodiments.

FIG. 9 is a graph that indicates a relationship between a distance from an optimal position in the x-axis direction and power of reflected light caused by Brillouin scattering according to one or more embodiments.

FIG. 10 is a graph that indicates a relationship between a distance from an optimal position in the x-axis direction and a Brillouin frequency shift according to one or more embodiments.

FIG. 11 is a graph that indicates measurement results of a Brillouin gain spectrum according to one or more embodiments.

FIG. 12 is a graph that indicates a relationship between a distance from an optimal position in the x-axis direction and power of reflected light caused by Brillouin scattering according to one or more embodiments.

FIG. 13 is a graph showing measurements results of a Brillouin gain spectrum according to one or more embodiments.

FIG. 14 is a graph showing measurements results of a Brillouin gain spectrum according to one or more embodiments.

FIG. 15 is a graph that indicates a relationship between a distance from an optimal position in the x-axis direction and power of reflected light caused by Brillouin scattering according to one or more embodiments.

### DETAILED DESCRIPTION OF THE INVENTION

Referring to Figures, the following description will discuss one example of a specific embodiment of an optical transmission line connection system and an optical transmission line connection method to which one or more embodiments of the present invention is applied in detail in the following sequence. Additionally, the present invention is not intended to be limited only by the following embodiments, and it is needless to say that various modifications may be made within the scope not departing from the gist of the invention.

1. Optical transmission Line Connection System

2. Optical transmission Line Connection Method

3. Examples

### 1. OPTICAL TRANSMISSION LINE CONNECTION SYSTEM

### 1-1. First Embodiment

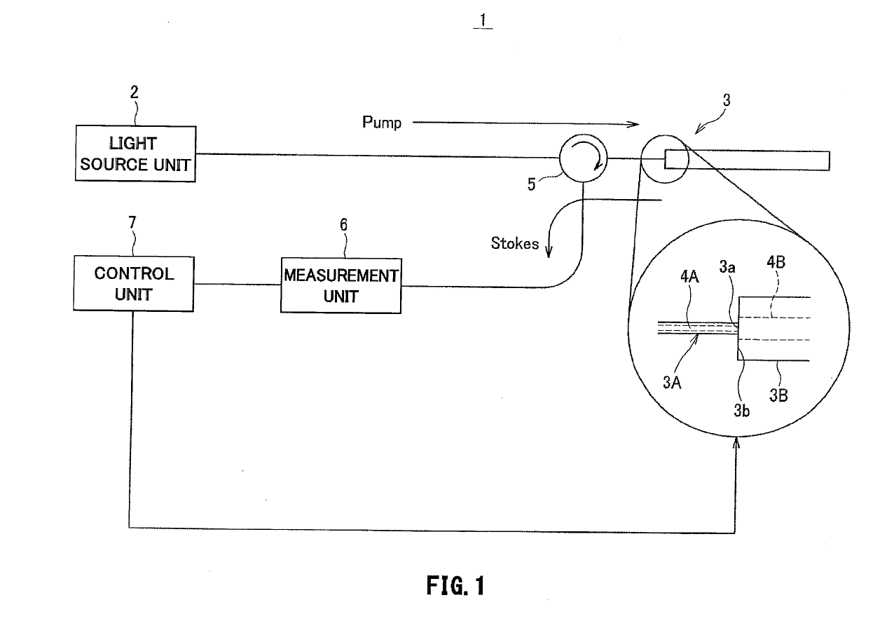

A optical transmission line connection system 1 shown in FIG. 1 is provided with a light source unit 2, a pump light generation unit 5 that allows laser light to pass through one end 3a of one optical transmission line 3A, and be made incident as pump light on one end 3b of the other optical transmission line 3B, a measurement unit 6 that observes (measures) non-linear scattered components contained in the reflected light from inside the other optical transmission line 3B, and a control unit 7 that evaluates the spectrum of the non-linear scattered components, and controls the position of the optical axis between the one end 3a of the one optical transmission line 3A and the one end 3b of the other optical transmission line 3B.

The light source 2 is configured by, for example, a semiconductor laser and a DC current supply, and outputs laser light. As the semiconductor laser, for example, a distributed feedback laser diode (DFB-LD) that has a small size and outputs laser light with a narrow spectral line width may be used.

The optical transmission line 3 has a core on which the laser light outputted by the light source unit 2 is made incident. The optical transmission line 3 is configured by, for example, a plate-shaped or sheet-shaped waveguide and an optical fiber. The optical transmission line 3 is made of, for example, an inorganic material or an organic material. As the inorganic material, quartz glass and silicon are proposed, and as the organic material, high purity polyimide-based resins, polyamide-based resins and polyether-based resins are proposed. The transmission lines 3A and 3B may be composed of the same material, or may be composed of different materials.

The pump light generation unit 5 is configured by an optical divider, a circulator, a beam splitter, a half mirror and the like, and laser light outputted by the light source unit 2 is made incident on one end 3b of the optical transmission line 3B as pump light via one end 3a of the optical transmission line 3A. Moreover, the pump light generation unit 5 allows the reflected light (stokes light) of the pump light reflected by the inside of the optical transmission line 3B to be made incident on the measurement unit 6.

The measurement unit 6 is constituted by, for example, an optical spectrum analyzer, on which the reflected light of the pump light is made incident from the inside of the optical transmission line 3B through the pump light generation unit 5, and observes variations of the intensity and frequency shift of non-linear scattered components contained in the reflected light. In this case, in the measurement unit 6, since only the simple measurements of the intensity of Rayleigh scattering causing no frequency change, that is, the simple measurements of the intensity of the reflected light, make unstable Fresnel reflected light on the one end 3b of the optical transmission line 3B mixed therein, it becomes difficult a realize a stable positioning process. Therefore, the measurement unit 6 observes Raman scattering or Brillouin scattering (in which the frequency is lowered upon reflection) that causes a frequency change upon reflection as non-linear scattered components. Thus, since the measurement unit 6 is allowed to observe the intensity of reflected light regardless of the Fresnel reflection components, it becomes possible to realize a stable positioning process.

As the non-linear scattered components, on principle, whichever scattered components, Raman scattered components or Brillouin scattered components, may be measured.

Brillouin scattering has an induction threshold value lower than that of Raman scattering; that is, it exerts a stronger scattering intensity in the case of the same input power. Moreover, the Brillouin scattering exerts a smaller downshift amount of the frequency in comparison with the Raman scattering. In this case, the frequency (central frequency) of the peak power of reflected light is downshifted relative to the central frequency v₀ of the pump light that is the incident light. The amount of this frequency shift is referred to as Brillouin frequency shift (v_{B}). The central frequency of the reflected light is lowered from the central frequency v₀ of the pump light by a value corresponding to the Brillouin frequency shift v_{B}, that is, (v₀-v_{B}). In this case, the amount of a downshift of the frequency is greatly dependent on the material of the optical transmission line, and, for example, in silica fibers, the Brillouin frequency shift is about 11 GHz, and the Raman frequency shift is about 13 THz. Moreover, the Brilloin scattering has a line width smaller than that of the Raman scattering. More specifically, in the case of the Brillouin scattering, the line width is several 10 MHz, while in the case of the Raman scattering, the line width is in the order of THz.

The control unit 7, which is constituted by, for example, a personal computer, evaluates the spectrum of non-linear scattered components contained in the reflected light from the optical transmission line 3B, and observed by the measurement unit 6, and controls the positions of the optical axes of the one end 3a of the optical transmission line 3A and the one end 3b of the optical transmission line 3B.

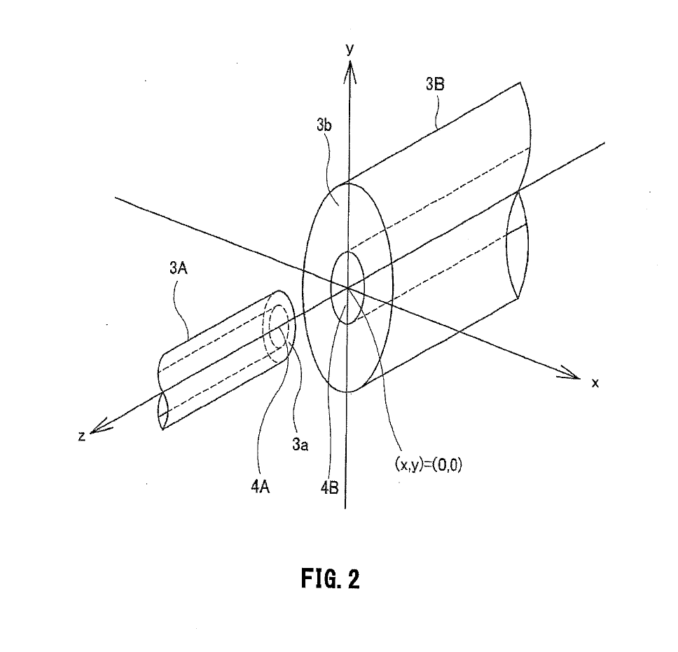

For example, as shown in FIG. 2, the control unit 7 is configured such that with one of the optical transmission line 3A and the optical transmission line 3B being secured onto a multi-axial movable stage (not shown) capable of being shifted along the X-axis, Y-axis and Z-axis, the position of the other optical transmission line 3 that is not secured onto the multi-axial movable stage is adjusted in the x-axis direction and the Y-axis direction, while applying feedback thereto by the actual time so as to make the intensity of the non-linear scattered components Brillouin scattered components observed by the measurement unit 6 the highest.

In the optical transmission line connection system 1, since the center of the core 4A of the optical transmission line 3A and the center of the core 4B of the optical transmission line 3B are position-adjusted with high precision, without using a connector, the connection between the optical transmission line 3A and the optical transmission line 3B can be made efficiently.

### 1-2. Second Embodiment

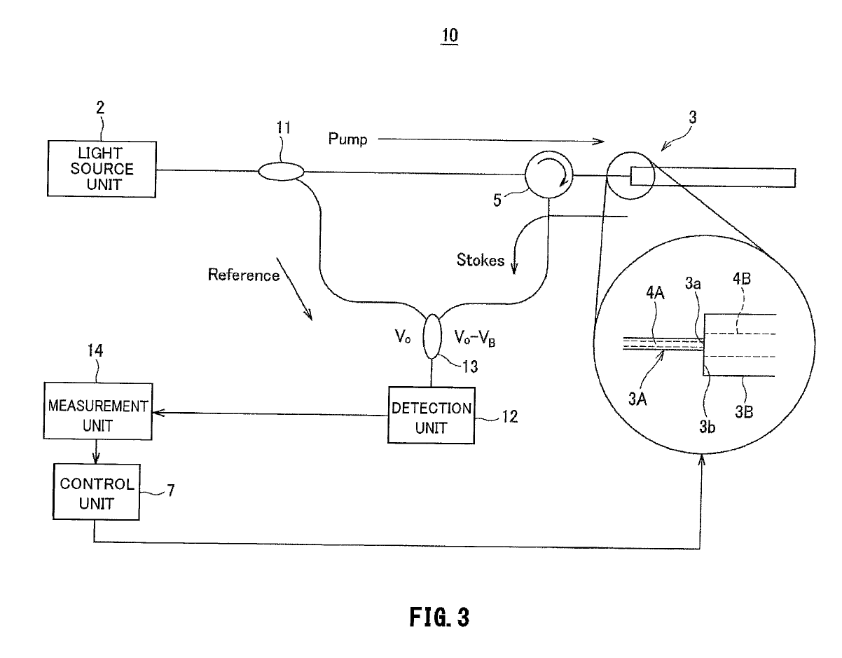

In order to achieve resolution higher than that of the above-mentioned optical transmission line connection system 1, an optical transmission line connection system 10 shown in FIG. 3 has a configuration different from that of the optical transmission line connection system 1 in the following points. First, the optical transmission line connection system 10 is provided with a reference light generation unit 11, a detection unit 12 and a photo-coupler 13. Moreover, the optical transmission line connection system 10 observes non-linear scattered components contained in an interference signal detected by the detection unit 12 in the measurement unit 14. Furthermore, the optical transmission line connection system 10 controls the positions of the optical axes of the one end 3a of the optical transmission line 3A and the one end 3b of the optical transmission line 3B so as to make the intensity of the non-linear scattered components of the interference signal observed by the measurement unit 6 in the control unit 7 the highest. Additionally, in the configuration of the optical transmission line connection system 10, those members that are the same as those of the aforementioned optical transmission line connection system 1 are indicated by the same reference numerals, and the detailed description thereof will be omitted.

The reference light generation unit 11 is configured by, for example, an optical divider, and generates reference light (Reference) from laser light outputted from the light source unit 2.

The detection unit 12, which is configured by a detection means of an optical heterodyne system composed of a detector unit such as, for example, a photodiode, detects the reference light from the reference light generation unit 11 and reflected light from the optical transmission line 3B, that is, stokes light (Stokes) respectively. The detection unit 12 makes the reference light and the reflected light having different frequencies interfered with each other (superposed with each other), and generates an interference signal having a frequency component corresponding to a difference between the reflected light and the reference light, that is, an electrical beat signal equivalent to the frequency difference between the reference light and the reflected light.

The measurement unit 14 is configured by, for example, an electrical spectrum analyzer (ESA) serving as a frequency analyzing means for observing the frequency characteristic of the beat signal outputted from the detection unit 12. The measurement unit 14 observes fluctuations in the Brillouin frequency shift as peak frequency fluctuations of the interference signal from the detection unit 12. The measured results in the measurement unit 14 are outputted to the control unit 7 as observation data.

To the control unit 7, the measured results in the measurement unit 14 are inputted. In the same manner as in the above-mentioned optical transmission line connection system 1, the control unit 7 controls the positions of the optical axes of the one end 3a of the optical transmission line 3A and the one end 3b of the optical transmission line 3B so as to make the intensity (or power that is in proportion to the intensity) of the non-linear scattered components of the interference signal observed by the measurement unit 14 the highest.

In the optical transmission line connection system 10, since the center of the core 4A of the optical transmission line 3A and the center of the core 4B of the optical transmission line 3B are position-adjusted with high precision, without using a connector, the connection between the optical transmission line 3A and the optical transmission line 3B can be made efficiently.

As described above, in the optical transmission connection system 10, the reference light optical path for use in heterodyne detection is installed, the detection unit 12 serving as the photo-detector that converts the optical beat signal to an electrical signal is incorporated, and the electrical spectrum analyzer is used as the measurement unit. With this configuration, in the case when the performances of the optical spectrum analyzer (frequency resolution, etc.) are not sufficient, the system may be applied to an optical transmission line 3 composed of a material having a small Brilliount frequency shift. Therefore, in the optical transmission line connection system 10, since the resolution can be made higher in comparison with the aforementioned optical transmission line connection system 1, it becomes possible to connect the optical transmission line 3A and the optical transmission line 3B with higher efficiency.

### 1-3. Third Embodiment

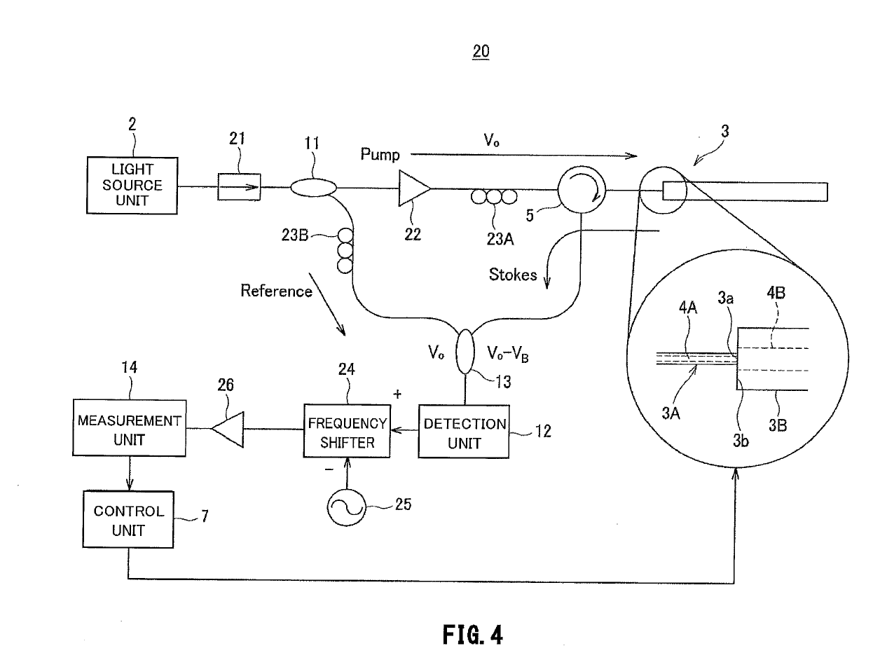

Moreover, in the case when the non-linear scattered components contained in reflected light from the inside of the optical transmission line 3B are not sufficiently high, an optical transmission line connection system 20 shown in FIG. 4 may be used. In addition to the configuration of the aforementioned optical transmission line connection system 10, the optical transmission line connection system 20 is further provided with an optical isolator 21, a photo-amplifier 22, polarized wave controllers 23A and 23B, a frequency shifter 24, an oscillator 25 and a preamplifier 26.

The optical isolator 21 allows laser light from the light source unit 2 to pass therethrough, and thereby prevents unnecessary return light to the light source unit 2 from being generated to make operations of the light source unit 2 unstable.

The photo-amplifier 22 is constituted by, for example, an erbium-doped fiber amplifier (EDFA), and amplifies the pump light from the reference light generation unit 11 to output the resulting light.

The polarized wave controller 23A adjusts the polarized wave state of the pump light from the photo-amplifier 22. Moreover, the polarized wave controller 23B adjusts the polarized wave state of the reference light generated by the reference light generation unit 11.

The frequency shifter 24 shifts the frequency of the interference signal detected by the detection unit 12 by using a frequency outputted from the oscillator 25, and outputs an interference signal with its frequency shifted to the preamplifier 26.

The preamplifier 26 amplifies the interference signal with its frequency shifted by the frequency shifter 24, and outputs the amplified interference signal to the measurement unit 6.

In accordance with this optical transmission line connection system 20, even in the case when the non-linear scattered components contained in reflected light from the inside of the optical transmission line 3B are not sufficiently high, since the center of the core 4A of the optical transmission line 3A and the center of the core 4B of the optical transmission line 3B are position-adjusted with high precision, the connection between the optical transmission line 3A and the optical transmission line 3B can be made with high efficiency.

### 2. OPTICAL TRANSMISSION LINE CONNECTION METHOD

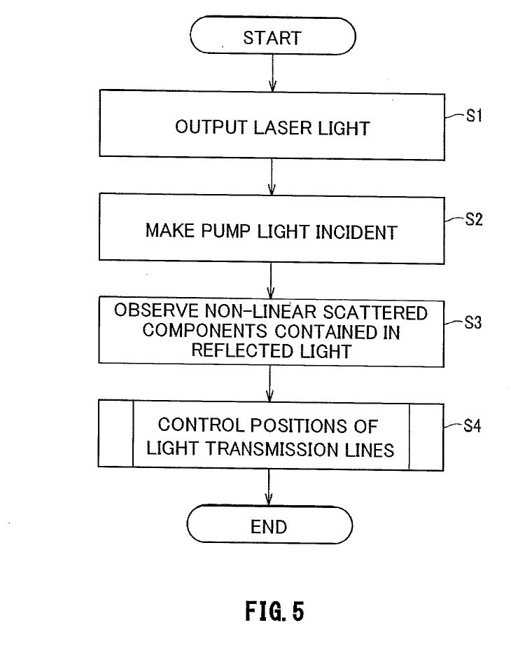

FIG. 5 is a flow chart for use in explaining one example of processes of an optical transmission line connection method in which the optical transmission line connection system 1 is used. The optical transmission line connection method includes an output step S1, a pump light generation step S2, a measuring step S3 and a control step S4.

In the output step S1, the light source unit 2 outputs laser light. In the pump light generation step S2, the pump light generation unit 5 allows the laser light outputted from the output step S1 to be made incident on the one end 3b of the optical transmission path 3B as pump light through the one end 3a of the optical transmission line 3A. In the measuring step S3, the measurement unit 6 observes non-linear scattered components contained in the reflected light from the inside of the optical transmission line 3B. In the control step S4, the control unit 7 controls the positions of the optical axes of the one end 3a of the optical transmission line 3A and the one end 3b of the optical transmission line 3B so as to make the intensity of the non-linear scattered components measured in measuring step S3 highest.

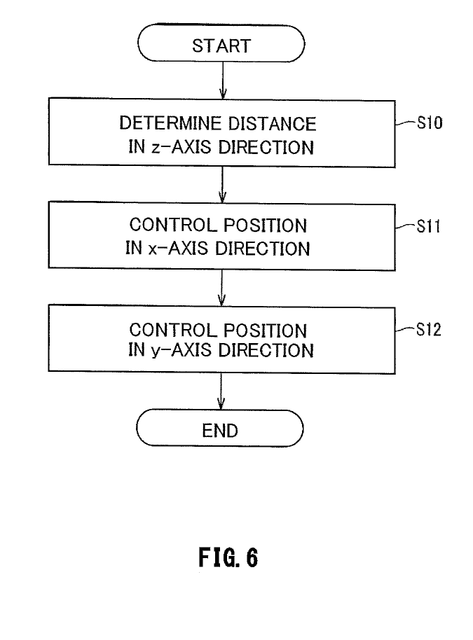

FIG. 6 is a flow chart for use in explaining one example of processes in the control step S4. The control step S4 includes a z-axis direction adjusting step S10, an x-axis direction adjusting step S11 and a y-axis direction adjusting step S12. The following description will exemplify a case in which the optical transmission line 3A shown in FIG. 2 is secured onto a multi-axial movable stage, with the optical transmission line 3B being not secured onto the multi-axial movable stage.

In the z-axis direction adjusting step S10, the control unit 7 adjusts the position of the optical transmission line 3B in the z-axis direction so that the one end 3a of the optical transmission line 3A and the one end 3b of the optical transmission line 3B are made closer to each other.

In the x-axis direction adjusting step S11, the control unit 7 adjusts the position of the optical transmission line 3B not secured onto the multi-axial movable state in the x-axis direction, while applying feedback thereto by the real time, so as to make the intensity of the non-linear scattered components observed in the measurement unit 6 the highest, with the optical transmission line 3A being secured onto the multi-axial movable stage.

In the y-axis direction adjusting step S12, the control unit 7 adjusts the position of the optical transmission line 3B in the y-axis direction, while applying feedback thereto by the real time, so as to make the intensity of the non-linear scattered components observed in the measurement unit 6 the highest.

In accordance with the optical transmission line connection method using the optical transmission line connection system 1, since the center of the core 4A of the optical transmission line 3A and the center of the core 4B of the optical transmission line 3B are position-adjusted with high precision, without using a connector, the connection between the optical transmission line 3A and the optical transmission line 3B can be made efficiently.

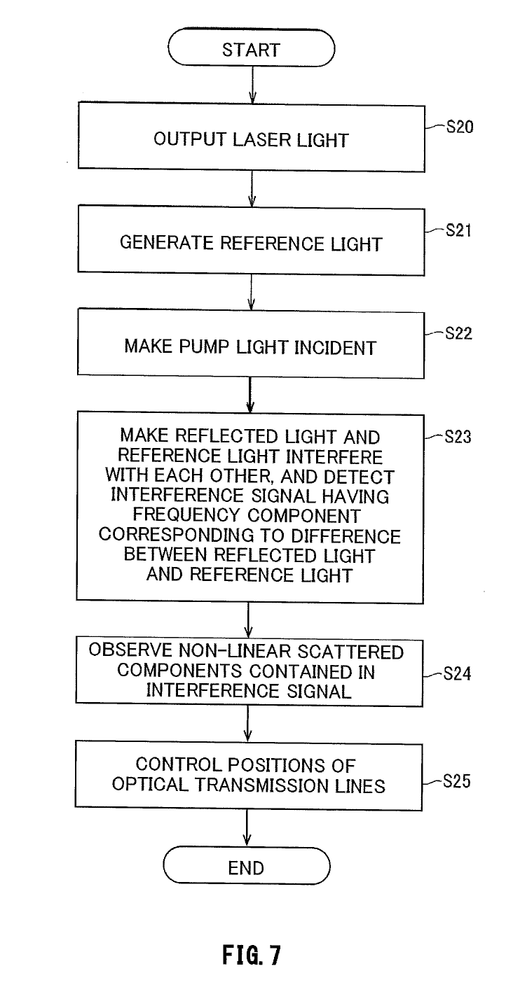

FIG. 7 is a flow chart for use in explaining one example of processes of an optical transmission line connection method in which the optical transmission line connection system 10 is used. This optical transmission line connection method is provided with an output step S20, a reference light generation step S21, a pump light generation step S22, a detection step S23, a measurement step S24 and a control step S25.

In the output step S20, the light source unit 2 outputs laser light. In the reference light generation step S21, the laser light from the lower source unit 2 is divided into two portions, and one portion is formed into pump light, with the other portion being formed into reference light. In the pump light generation step S22, the pump light generation unit 5 allows the laser light outputted by the output step S1 to be made incident on the one end 3b of the optical transmission line 3B through the one end 3a of the optical transmission line 3A as pump light. In the detection step S23, the detection unit 12 makes reflected light generated by non-linear scattering inside the optical transmission line 3B and the reference light interfered with each other, and detects an interference signal having a frequency component corresponding to a difference between the reflected light and the reference light. In the measurement step S24, the measurement unit 6 observes non-linear scattered components contained in the reflected light from the inside of the optical transmission line 3B. In the control step S25, the control unit 7 controls the positions of the optical axes of the one end 3a of the optical transmission line 3A and the one end 3b of the optical transmission line 3B so as to make the intensity of the non-linear scattered components measured in measuring step S3 highest.

In accordance with the optical transmission line connection method using the optical transmission line connection system 10, since a higher resolution can be obtained in comparison with the above-mentioned optical transmission line connection system 1, it becomes possible to connect the optical transmission line 3A and the optical transmission line 3B with higher efficiency.

Additionally, the above description has exemplified a configuration in which the positions of the optical axes of the one end 3a of the optical transmission line 3A and the one end 3b of the optical transmission line 3B are controlled so as to make the intensity of spectrum of non-linear scattered components the highest; however, the present invention is not intended to be limited by this configuration. For example, by evaluating the shift amount of the frequency of spectrum of non-linear scattered components in the control device 7, the positions of the optical axes of the one end 3a of the optical transmission line 3A and the one end 3b of the optical transmission line 3B may be controlled. Moreover, by evaluating the line width of spectrum of non-linear scattered components in the control device 7, the positions of the optical axes of the one end 3a of the optical transmission line 3A and the one end 3b of the optical transmission line 3B may be controlled.

Moreover, the above explanation of an optical transmission line connection method has exemplified a configuration in which the optical transmission line 3A is secured onto the multi-axial movable stage, with the optical transmission line 3B being not secured onto the multi-axial movable stage; however, the present invention is not intended to be limited by this configuration. For example, with the optical transmission line 3A and the optical transmission line 3B being secured onto the multi-axial movable stage, the positions of the optical axes of the optical transmission line 3A and the optical transmission line 3B may be controlled. Moreover, the processes of the connection step S4 shown in FIG. 6 are not limited by the above-mentioned examples, and for example, the process of the z-axis direction adjusting step S10 may be executed lastly.

### 3. EXAMPLES

Next, the following description will discuss specific examples of the present invention. However, the scope of the present invention is not intended to be limited by any of the following examples.

In the present example, as its measuring system, an optical transmission line connection system shown in FIG. 4 was used. As its light source unit, a distributed feedback laser diode (DFB-LD) of 1552 nm was used. As its optical transmission line, a silica single-mode fiber (Silica SMF, hereinafter, referred to as “SMF”), and refractive-index inclination-type multi-mode fibers (Silica GI-MMF, PFGI-POF(A), PFGI-POF(B)) of three kinds having different core diameters were used. The Silica GI-MMF was composed of silica, and the PFGI-POF(A) and POF(B) were composed of total fluoridated polymers. As its amplifier, an erbium-doped fiber amplifier (EDFA) was used. As its detection unit, a photodetector was used. As its measurement unit, an electrical spectrum analyzer (ESA) was used.

In the present examples, experiments were carried out in which the SMF and the refractive-index inclination-type multi-mode fiber were abutted against and joined to each other. The materials and structural constants of the SMF and the refractive-index inclination-type multi-mode fiber are shown in the following Table 1.

TABLE 1

| | d | | | α | L |
|---|---|---|---|---|---|
| Fiber | (μm) | neff | NA | (dB/km) | (m) |
| Silica SMF | 8 | −1.47 | 0.13 | −0.5 | 1.6 |
| Silica | 50 | −1.46 | 0.2 | −1 | 100 |
| GI-MMF | | | | | |
| PFGI-POF(A) | 62.5 | −1.35 | 0.185 | −150 | 5 |
| PFGI-POF(B) | 120 | −1.35 | 0.185 | −150 | 100 |

In Table 1, d represents the diameter of a core (μm), n_{eff} represents the effective refractive index of the core, NA represents the numerical aperture, α represents the transmission loss (dB/km) and L represents the length (m) of an optical fiber.

### Example 1

The position of an SMF was secured, and a GI-MMF was attached to a three-axis positioning stage. In this case, the x-axis, y-axis and z-axis of the three-axis positioning stage were defined as shown in FIG. 2. The positioning of optical fibers was carried out in the following manner. First, relative angles of respective optical fibers to be abutted against and joined to each other were adjusted. Successively, a refractive-index matching oil (n=1.46) was applied onto one end of each optical fiber so as to fill the air gap of the one end of each optical fiber and suppress Fresnel reflection from occurring therein. Then, the z-axis was adjusted so as to make the gap of the ends of the respective optical fibers virtually 0. Lastly, the positions in the x-axis direction and the y-axis direction of the GI-MMF were adjusted by using a method explained below. Thus, the SMF and the GI-MMF were abutted against and joined to each other.

Output light from the distributed feedback laser diode was divided into two portions in the reference light generation unit, and one of the divided output light was formed into pump light while the other output light was formed into reference light. The pump light was amplified by an erbium-doped fiber amplifier, and after the polarized wave state had been adjusted by a polarized wave controller, the resulting pump light was made incident on the GI-MMF through the abutted and joined lines. The reflected light from the GI-MMF was wave-combined with the reference light so that an interference signal (beat signal) having a frequency component corresponding to a difference between the reflected light and the reference light was formed into an electric signal by a photo-detector. The interference signal detected by the detection unit was frequency-shifted by a frequency shifter with 9 GHz, and after having been amplified to 23 dB by a preamplifier, the resulting signal was observed by an electrical spectrum analyzer. The control unit controlled the positions in the x-axis direction and the y-axis direction of the GI-MMF mounted onto the three-axis positioning stage, while applying feedback thereto by the actual time, so as to make the intensity of Brillouin scattered components contained in the interference signal observed by the electrical spectrum analyzer the highest.

### Example 2

In example 2, the same processes as those of example 1 were carried out except that in place of the GI-MMF, a PFGI-POF (A) was mounted on the three-axis positioning stage and that no frequency shifter was introduced.

### Example 3

In example 3, the same processes as those of example 1 were carried out except that in place of the GI-MMF, a PFGI-POF (B) was mounted on the three-axis positioning stage and that no frequency shifter was introduced.

### Results of Experiments

### Example 1

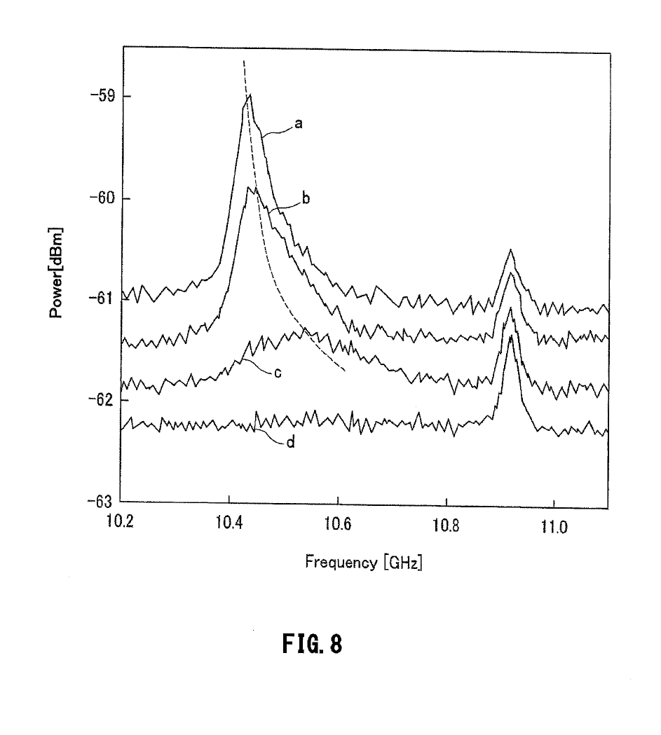

FIG. 8 is a graph showing measured results of Brillouin gain spectrum obtained by the electrical spectrum analyzer in example 1. More specifically, a GI-MMF mounted onto the three-axis positioning stage was secured at a position of 0 μm in the y-axis, and Brillouin gain spectrum was observed at each of positions in the x-axis of 0 μm (symbol a), −10 μm (symbol b), −20 μm (symbol c) and −30 μm (symbol d), and shown therein. Optical power (Pᵢₙ) at one end of the SMF was fixed to 15 dBm.

As shown in FIG. 8, peaks were observed respectively at the vicinity of 10.5 GHz and as the vicinity of 10.92 GHz in the Brillouin gain spectrum. The peak at the vicinity of 10.5 GHz was derived from a Brillouin stokes signal (Brillouin scattered components) of the GI-MMF. The peak at the vicinity of 10.92 GHz was derived from a Brillouin stokes signal of the SMF. It was found that as the absolute value of x (|x|) increases, the maximum output of the Brillouin stokes signal of the GI-MMF is drastically reduced.

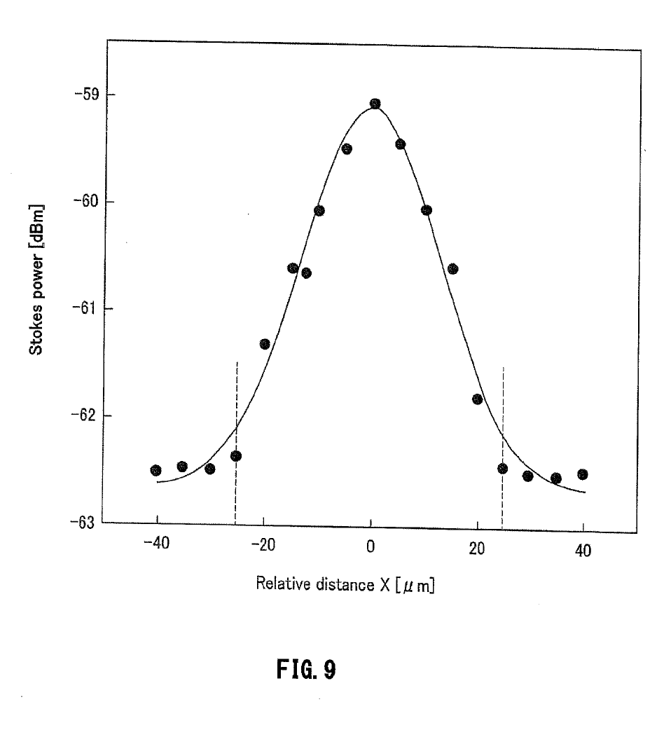

FIG. 9 is a graph that indicates a relationship between a distance from an optimal position in the x-axis direction and power of reflected light caused by Brillouin scattering. The axis of abscissas in FIG. 9 indicates a distance from the optimal position (core center of GI-MMF) in the x-axis direction of the GI-MMF. Moreover, the axis of ordinates in FIG. 9 indicates power in the Brillouin stokes signal in the GI-MMF. A broken line on the axis of abscissas in FIG. 9 indicates the inside of the core of the GI-MMF by its inside.

As shown in FIG. 9, it was found that when x is 0 μm, the power of the Brillouin stokes signal is maximized, and that as the absolute value of x increases, the power of the Brillouin stokes signal is reduced. Moreover, in the outside of the range of the core region of the GI-MMF, that is, |x|>25 μm, the Brillouin stokes signal becomes smaller than noises. This behavior is well matched with the Gaussian distribution. From these results, it is found that by observing the power of the Brillouin stokes signal of the GI-MMF, the core center of the SMF and the core center of the GI-MMF can be abutted against and joined to each other with high efficiency, without using a connector.

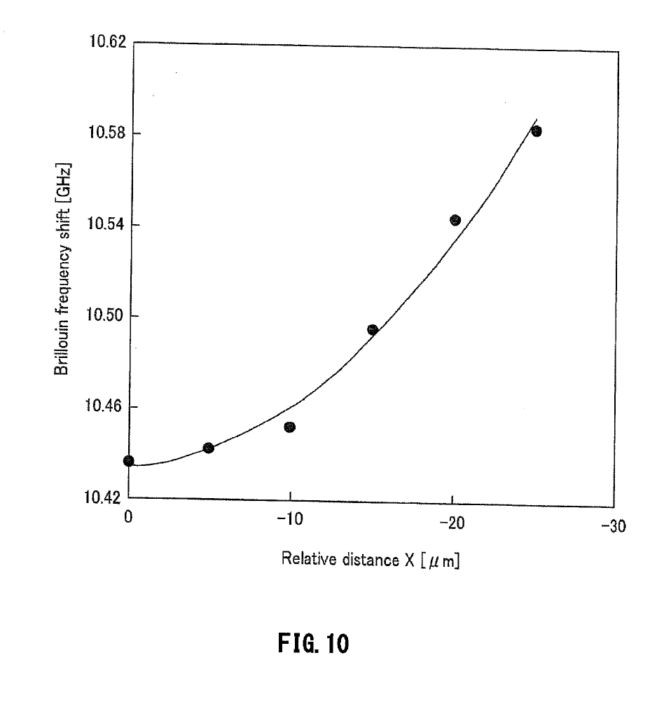

FIG. 10 is a graph that indicates a relationship between a distance from an optimal position in the x-axis direction and a Brillouin frequency shift. As shown in FIG. 10, it was found that not only the power of the Brillouin stokes signal, but also the amount of a frequency shift is dependent on x. That is, it was found that in proportion to the root of the absolute value of x, the frequency shift of the GI-MMF varies. From these results, it was clarified that by observing the amount of Brillouin frequency shift, the core center of the SMF and the core center of the GI-MMF can be abutted against and joined to each other with high efficiency.

### Example 2

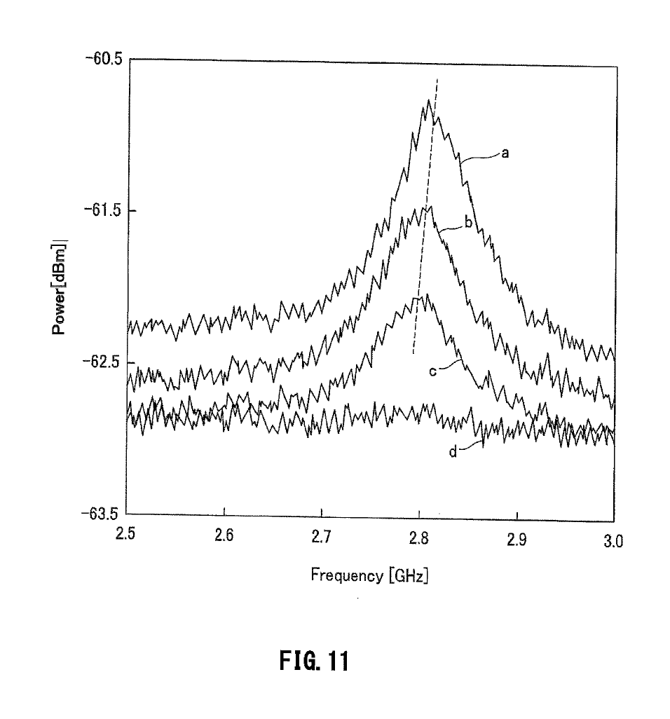

FIG. 11 is a graph that indicates measurement results of a Brillouin gain spectrum obtained in an electrical spectrum analyzer. More specifically, a PFGI-POF(A) mounted onto the three-axis positioning stage was secured at a position of 0 μm in the y-axis, and Brillouin gain spectrum was observed at each of positions in the x-axis of 0 μm (symbol a), −15 μm (symbol b), −20 μm (symbol c) and −30 μm (symbol d), and shown therein. Optical power (Pᵢₙ) at one end of the SMF was fixed to 12 dBm.

As shown in FIG. 11, the only one Brillouin gain spectrum of the PFGI-POF(A) was observed in a range from 2.5 to 3.0 GHz.

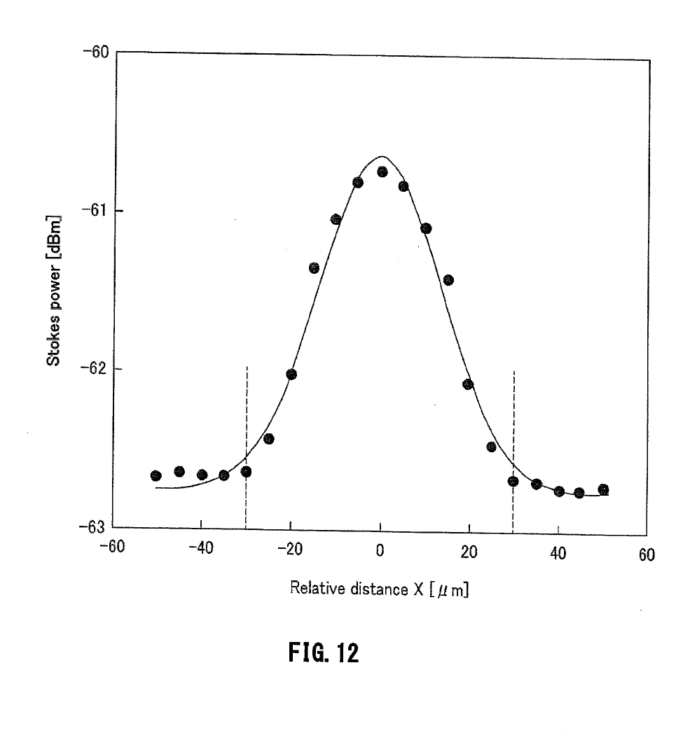

FIG. 12 is a graph that indicates a relationship between a distance from an optimal position in the x-axis direction and power of reflected light caused by Brillouin scattering. The axis of abscissas in FIG. 12 indicates a distance from the optimal position (the core center of the PFGI-POF(A)) in the x-axis direction of the PFGI-POF(A). Moreover, the axis of ordinates in FIG. 12 indicates power of a Brillouin stokes signal in the PFGI-POF(A). A broken line on the axis of abscissas in FIG. 12 indicates the inside of the core of the PFGI-POF(A) by its inside.

As shown in FIG. 12, the resulting power from the Brilloin stokes signal relative to x was the same as that of example 1 shown in FIG. 9. As a result, it was found that in the same manner as in example 2, even in the case when optical fibers (SMF and PFGI-POF) composed of different materials are mutually abutted against and joined to each other, the connection thereof can be made efficiently.

### Example 3

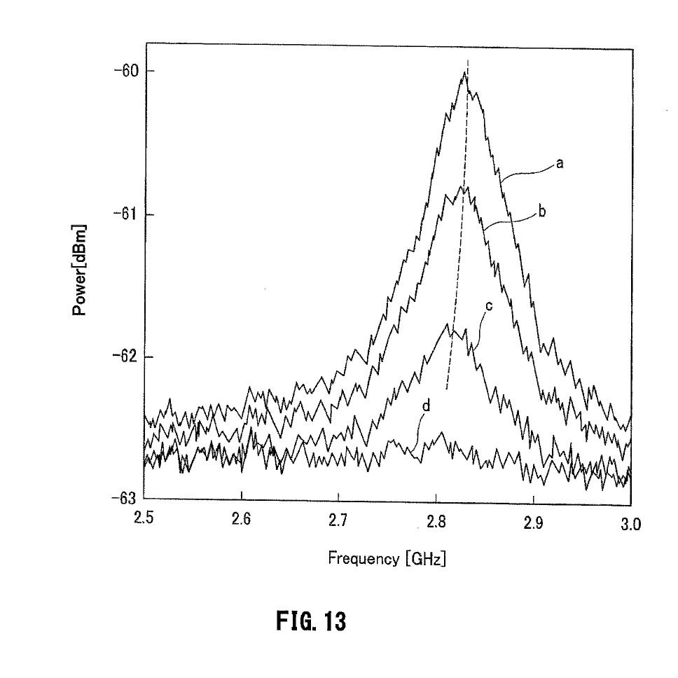

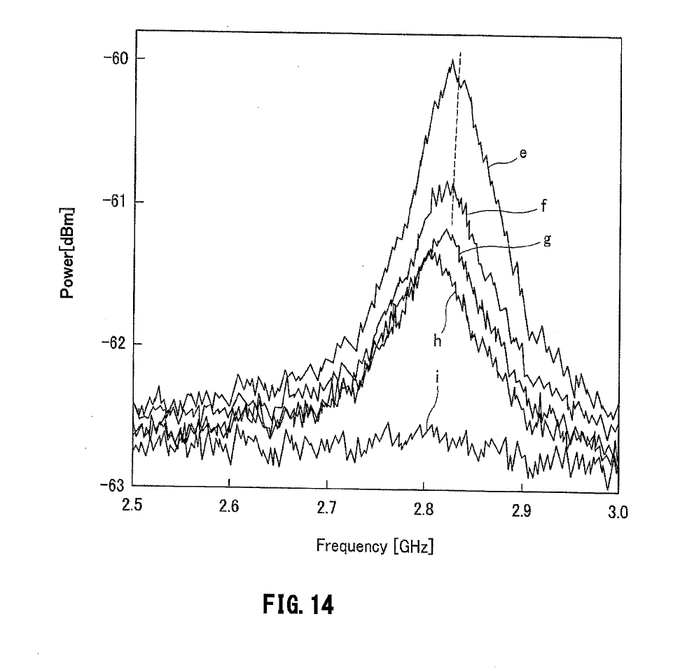

FIGS. 13 and 14 are graphs showing the results of distribution measurements of a Brillouin gain spectrum obtained in the electrical spectrum analyzer in example 3. More specifically, a PFGI-POF(B) mounted onto the three-axis positioning stage was secured at a position of 0 μm in the y-axis, and Brillouin gain spectrum (FIG. 13) was observed at each of positions in the x-axis of 0 μm (symbol a), 20 μm (symbol b), 40 μm (symbol c) and 60 μm (symbol d), as well as at each of positions in the x-axis of 0 μm (symbol e), −20 μm (symbol f), −30 μm (symbol g), −40 μm (symbol h) and −60 μm (symbol i), and each of the Brillouin spectra thus observed was shown (FIG. 14). Optical power (Pᵢₙ) at one end of the SMF was fixed to 15 dBm.

As shown in FIGS. 13 and 14, the only one Brillouin gain spectrum of the PFGI-POF(B) was observed in a range from 2.5 to 3.0 GHz. Moreover, from the results shown in FIG. 14, it was found that hardly any change occurs in the power of the Brillouin stokes signal in the range of x from −40 μm to −30 μm. It was confirmed from examinations by the use of an optical fiber microscope that this behavior was derived from a comparatively rough surface of the terminal end of the PFGI-POF(B).

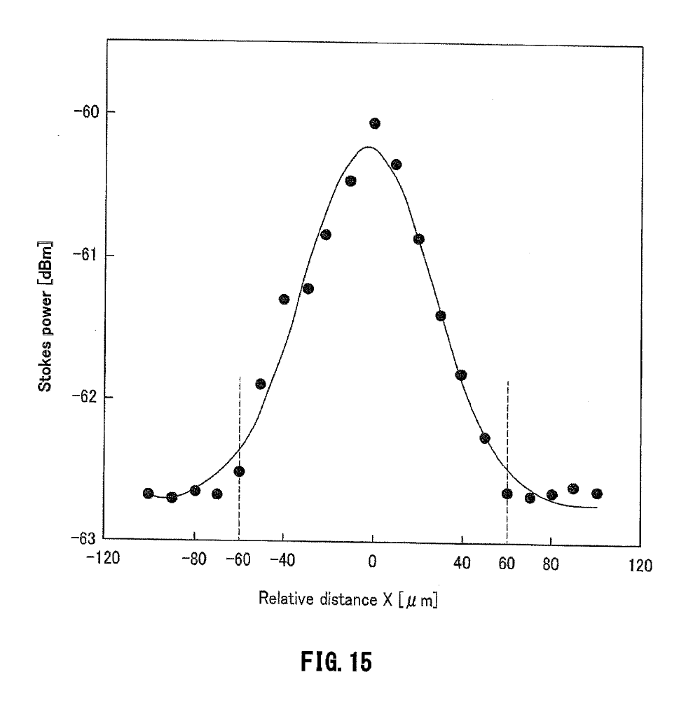

FIG. 15 is a graph that indicates a relationship between a distance from an optimal position in the x-axis direction and power of reflected light caused by Brillouin scattering. The axis of abscissas in FIG. 15 indicates a distance from the optimal position (the core center of the PFGI-POF(B)) in the x-axis direction of the PFGI-POF(B). Moreover, the axis of ordinates in FIG. 15 indicates power of a Brillouin stokes signal in the PFGI-POF(B). A broken line on the axis of abscissas in FIG. 15 indicates the inside of the core of the PFGI-POF(B) by its inside. As shown in FIG. 15, the resulting power from the Brillouin stokes signal relative to x was the same as those of examples 1 and 2. As a result, it is found that the connection between the SMF and the PFGI-POF(B) serving as optical transmission lines can be efficiently made without using a connector.

1. An optical transmission line connection system for allowing two optical transmission lines to be abutted against and joined to each other, comprising:
a light source unit that outputs laser light;
a pump light generation unit that allows the laser light outputted from the light source unit to pass through one end of one of the optical transmission lines and be made incident on one end of the other optical transmission line as pump light;
a measurement unit that measures non-linear scattered light components contained in reflected light, the reflected light being derived from the pump light transmitted through inside the other optical transmission line; and
a control unit that evaluates a spectrum of the non-linear scattered components measured by the measurement unit, and controls positions of optical axes of the one end of the one optical transmission line and the one end of the other optical transmission line so as to position the optical axes and maximize an intensity of the non-linear scattered light components.

2. The optical transmission line connection system according to claim 1, further comprising:
a reference light generation unit that generates reference light and the pump light from the laser light outputted from the light source unit; and
a detection unit that makes the reflected light from the inside the other optical transmission line and the reference light interfere with each other, and detects an interference signal having a frequency component corresponding to a difference between the reflected light and the reference light,
wherein the measurement unit measures non-linear scattered components contained in the interference signal detected by the detection unit, and
the control unit evaluates a spectrum of the non-linear scattered components of the interference signal measured by the measurement unit, and controls the positions of the optical axes of the one end of the one optical transmission line and the one end of the other optical transmission line.

3. The optical transmission line connection system according to claim 2,
wherein the measurement unit measures Brillouin scattered components contained in the interference signal as the non-linear scattered components, and
the control unit evaluates a spectrum of the Brillouin scattered components measured by the measurement unit and controls the positions of the optical axes of the one end of the one optical transmission line and the one end of the other optical transmission line.

4. The optical transmission line connection system according to claim 3, wherein the control unit controls the positions of the optical axes of the one end of the one optical transmission line and the one end of the other optical transmission line so as to maximize the intensity of the Brillouin scattered components.

5. An optical transmission line connecting method for allowing two optical transmission lines to be abutted against and joined to each other, comprising:
outputting laser light;
allowing the laser light outputted from the light source unit to pass through one end of one of the optical transmission lines and be made incident on one end of the other optical transmission line as pump light;
measuring non-linear scattered light components contained in reflected light, the reflected light being derived from the pump light transmitted through inside the other optical transmission line; and
by evaluating a spectrum of the non-linear scattered components measured by the measuring, controlling positions of optical axes of the one end of the one optical transmission line and the one end of the other optical transmission line so as to position the optical axes and maximize an intensity of the non-linear scattered light components.
